(19) United States
(12) Patent Application Publication
(10) Pub. No.: US 2023/0274330 A1
(43) Pub. Date: Aug. 31, 2023

(54) SYSTEMS AND METHODS FOR FACILITATING CUSTOM MANUFACTURING

(71) Applicant: EllansaLabs Inc., Addison, TX (US)

(72) Inventors: Omar Besim Hakim, Austin, TX (US); Orlando Altamar, Dallas, TX (US); Barry Boland, Dallas, TX (US); Aleta Keeling, Dallas, TX (US)

(21) Appl. No.: 18/313,947

(22) Filed: May 8, 2023

Related U.S. Application Data
(60) Provisional application No. 63/350,339, filed on Jun. 8, 2022.
(60) Provisional application No. 63/339,356, filed on May 6, 2022.

(51) Int. Cl. G06Q 30/0601; G06Q 10/0631

(52) U.S. Cl. CPC G06Q 30/0621; G06Q 10/06315; G06Q 30/0641

(57) ABSTRACT

Examples provide an enterprise resource planning server system for facilitating manufacturing of custom products. The system includes at least one network communication interface configured to communicate over a network with electronic devices, and at least one server electronic processor configured to receive a design request for a design, and iteratively generate a design data based, at least in part, on the design request. The design data at least includes a 3D graphics file and specification parameters. The at least one electronic processor receives a purchase request associated with the design, selects at least one manufacturer for manufacturing the design, generates a manufacturing request based on the purchase request, and transmits the manufacturing request to a selected manufacturer.

### RELATED APPLICATIONS

This application claims the benefit of U.S. Provisional Patent Application No. 63/339,356, filed May 6, 2022, and U.S. Provisional Patent Application No. 63/350,339, filed Jun. 8, 2022, the entire contents of which are hereby incorporated by reference.

### FIELD

Embodiments disclosed herein relate to custom product manufacturing.

### SUMMARY

Designers, and in particular, designers of fine custom products (e.g., jewelry, furniture, clothing, etc.), often sell their product in small batches. If a designer receives a sudden surge of orders, the designer may struggle to manage the supply chain associated with each order. For example, the designer may have difficulty finding manufacturers with sufficient manufacturing capacity or raw materials. Additionally, raw materials for luxury products, such as fine jewelry, are often very expensive. Designers who maintain a large inventory of raw materials may suffer financially if they do not receive sufficient and/or continuous orders. Accordingly, there is a need for facilitating the manufacturing of custom products for designers to balance these competing issues.

Thus, one example provides an enterprise resource planning server system for facilitating manufacturing of custom jewelry. The system includes at least one network communication interface configured to communicate over a network with electronic devices; a memory storing a computer program; and at least one server electronic processor configured by way of the computer program to: receive a design request for a jewelry design; generate jewelry design data based on the design request, wherein the jewelry design data includes at least a 3D graphics file and specification parameters; provide the jewelry design data to a user; receive feedback from the user; modify the jewelry design data based on feedback; receive a jewelry purchase request associated with the jewelry design; responsive to receiving the jewelry purchase request, select a jewelry manufacturer for manufacturing the jewelry design; generate a manufacturing request based on the jewelry purchase request; and transmit the manufacturing request to a selected jewelry manufacturer.

In some aspects, the feedback includes a request to modify at least one selected from the group consisting of a price associated with the design, one or more materials associated with the design, a removal of one or more components included in the design, an addition of one or more components to the design, a size of one or more components included in the design, and a location of one or more components included in the design.

Another example provides an enterprise resource planning server system for facilitating manufacturing of custom products. The system includes at least one network communication interface configured to communicate over a network with electronic devices; and at least one server electronic processor configured to: receive a design request for a design; generate design data based, at least in part, on the design request, wherein the design data includes at least a graphics file and specification parameters; receive a purchase request associated with the design; responsive to receiving the purchase request, select at least one manufacturer for manufacturing the design; generate a manufacturing request based on the purchase request; and transmit the manufacturing request to a selected manufacturer.

In some aspects, the design request includes at least one selected from the group consisting of: a 2D vector file, raster file, an image, or a text description of the design.

In some aspects, the at least one server electronic processor is further configured to generate the design data iteratively by: providing an initial design data to a user; responsive to providing the initial design data, receiving a design modification request from the user; generating modified design data based on the design modification request; and providing the modified design data to the user.

In some aspects, the design modification request includes a request to modify at least one selected from the group consisting of: a price associated with the design, one or more materials associated with the design, a removal of one or more components included in the design, an addition of one or more components to the design, a size of one or more components included in the design, and a location of one or more components included the design.

In some aspects, the at least one server electronic processor is configured to generate the design data iteratively by: using a machine learning module, generating the graphics file as a 3D graphics file based on the design request.

In some aspects, the machine learning module is configured to receive, as training data, at least one selected from the group consisting of: the design modification request and the modified design data.

In some aspects, the at least one server electronic processor generates the specification sheet based on the graphics file.

In some aspects, the design data includes a price associated with the design.

In some aspects, the purchase request is included in the design request.

In some aspects, the purchase request includes a total order quantity for the design, and wherein the at least one server electronic processor is configured to select the at least one manufacturer for manufacturing the design based on the total order quantity.

In some aspects, the at least one server electronic processor is configured to select a first manufacturer and a second manufacturer, the manufacturing request includes a first manufacturing request to be transmitted to the first manufacturer and a second selected manufacturing request to be transmitted to the second manufacturer, and the first manufacturing request includes a first order quantity that is less than the total order quantity and the second manufacturing request includes a second order quantity that is less than the total order quantity.

In some aspects, the specification sheet includes an identification of raw materials included in the design, and the at least one server electronic processor is configured to select the at least one manufacturer for manufacturing the design based on the identification of raw materials.

In some aspects, the at least one server electronic processor is configured to select the at least one manufacturer in response to receiving a manufacturing bid from the at least one manufacturer.

In some aspects, the at least one server electronic processor is further configured to: responsive to transmitting the manufacturing request to the selected manufacturer, receive quality control data from the selected manufacturer, wherein the quality control data includes at least one selected from the group consisting of: an augmented reality file, a virtual reality file, a video file, an image file, and a text description of a manufactured piece.

In some aspects, the at least one server electronic processor is further configured to: responsive to receiving the quality control data, selectively transmit, to the selected manufacturer, an approval or rejection of the manufactured piece, wherein the at least one server electronic processor determines whether to transmit the approval or the rejection based on the quality control data and an output from a machine learning model.

In some aspects, the purchase request includes payment information, and the at least one server electronic processor is further configured to: responsive to receiving the purchase request, store the payment information; and responsive to transmitting an approval of the manufactured piece, release a payment to the selected manufacturer.

In some aspects, the at least one server electronic processor is further configured to: store a project file associated with the design, wherein the project file includes at least one selected from the group consisting of: the quality control data, the design data, the design request, and the purchase request.

Another example provides an enterprise resource planning server system. The system includes at least one network communication interface configured to communicate over a network with electronic devices; and at least one server electronic processor configured to: receive, from a user, a purchase request to purchase a custom product, the purchase request including payment information; store the payment information in a memory; select at least one manufacturer for manufacturing the custom product based on at least one selected from the group consisting of: a total order quantity associated with the purchase request, raw materials included in a design of the custom product, a bid from the at least one manufacturer, a product cost, and stored quality control data associated with the at least one manufacturer, generate a manufacturing request based on the purchase request; transmit the manufacturing request to a selected manufacturer; receive an indication that the at least one manufacturer completed manufacture of the custom product, receive quality control data associated with the custom product, determine whether the quality control data meets a set of quality control parameters, responsive to determining that the quality control data meets a set of quality control parameters, release a payment, using the payment information, to the at least one manufacturer.

### BRIEF DESCRIPTION OF THE DRAWINGS

FIG. 1 schematically illustrates a system for facilitating custom manufacturing, according to some examples.

FIG. 2 is a flowchart illustrating a method for facilitating custom manufacturing, according to some examples.

FIG. 3 is a flowchart illustrating a method for iteratively generating the design data set, according to some examples.

FIG. 4 is a flowchart illustrating a method for performing quality control of a manufactured custom product, according to some examples.

FIG. 5 is a flowchart illustrating a method for performing an escrow process, according to some examples.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not listed. Furthermore, some embodiments described herein may include one or more electronic processors configured to perform the described functionality by executing instructions stored in a non-transitory, computer-readable medium. Similarly, embodiments described herein may be implemented as non-transitory, computer-readable mediums storing instructions executable by one or more electronic processors to perform the described functionality. As used in the present application, “non-transitory computer-readable medium” comprises all computer-readable media but does not consist of a transitory, propagating signal. Accordingly, a non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

It should also be understood that although certain drawings illustrate hardware and software located within particular devices, these depictions are for illustrative purposes only. In some embodiments, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations. To reiterate, those electronic processors and processing may be distributed.

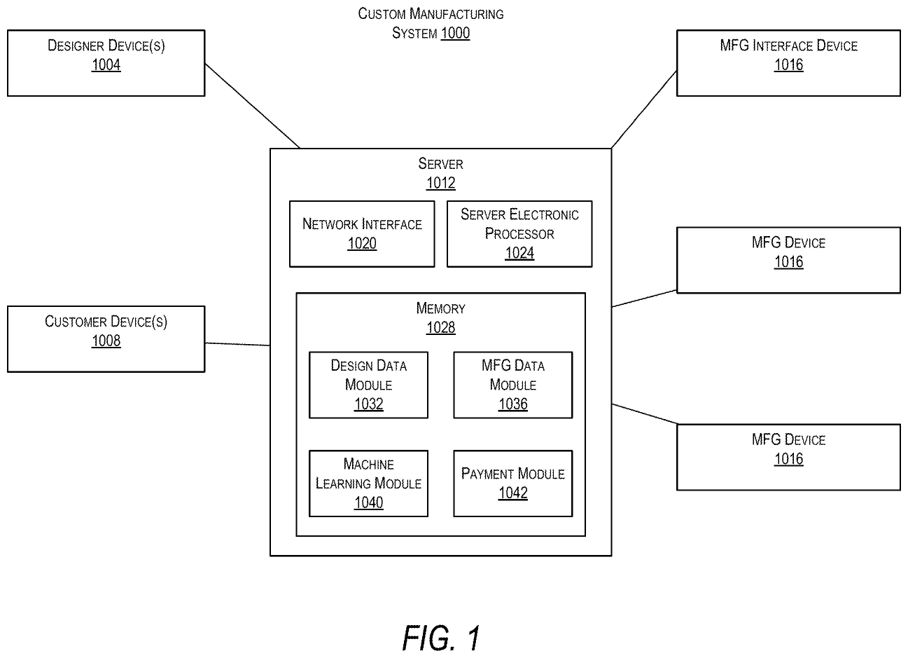

FIG. 1 schematically illustrates a custom product manufacturing system 1000 according to some embodiments, which may be in the form of, for example, a jewelry manufacturing system. Although the system 1000 is in no way limited to the manufacture of custom jewelry and is applicable for other custom products, such an embodiment is used throughout for ease of example.

The jewelry manufacturing system 1000 may include a designer electronic device 1004, a customer electronic device 1008, a server 1012, and a plurality of manufacturing electronic devices 1016. While the system 1000 is illustrated as including three manufacturing devices 1016, the system 1000 may include more than three manufacturing devices 1016 or fewer than three manufacturing devices 1016. Similarly, the system 1000 may include more than one customer electronic device 1004 and/or more than one designer electronic device 1008.

The server 1012 may be a cloud-based enterprise resource planning server 1012 and may include a network communication interface 1020, an electronic processor 1024, and a memory 1028. The network interface 1020 may be configured to enable communication between the server 1012 and the designer electronic device 1004, the customer electronic device 1008, and the plurality of manufacturing electronic devices 1016. In some embodiments, the network interface 1020 is configured to transmit and receive requests between the server 1012 and the designer electronic device 1004, the customer electronic device 1008, and the plurality of manufacturing electronic devices 1016 using one or more web service APIs.

The server 1012 may provide, using the electronic processor 1024, a different interface for each type of user. For example, the server 1012 provides a designer interface to the designer electronic device 1004, a customer interface to the customer electronic device 1008, and a manufacturing interface to the manufacturing electronic device 1016. In some instances, a user of the system 1000 may be both a designer and a purchaser of the manufactured designs. Therefore, the designer electronic device 1004 and the customer electronic device 1008 may be the same device, and the server 1012 provides both the customer interface and the designer interface to the device. In some instances, a user of the system 1000 is both a manufacturer and a designer, and the designer electronic device 1004 and the manufacturer electronic device 1016 are therefore the same device. The server 1012 may therefore provide both the manufacturing user interface and the designer user interface to the device. Accordingly, the designer electronic device 1004, the customer electronic device 1008, and the manufacturing electronic device 1016 may alternatively be referred to herein as the designer interface 1004, the customer interface 1008, and the manufacturing interface 1016, respectively.

The memory 1028 may include computer software executable by the electronic processor 1024, a design data module 1032, a manufacturing data module 1036, a machine learning module 1040, and a payment module 1042. The electronic processor 1024 may be implemented in a distributed manner using one or more electronic processors. In some instances, the server 121 is implemented in a distributed manner using multiple servers 1012 and including multiple electronic processors 1024 together configured to perform the methods described herein.

The design data module 1032 may be configured to store jewelry design data from the designer electronic device 1004. For example, the design data module 1032 may store a designer user profile associated with each designer (e.g., each designer electronic device). Each designer user profile may be linked to one or more project files including design data associated with each project. In some instances, each designer user profile also stores data indicating a field of expertise associated with the designer (e.g., leatherworking, metalworking, etc.). In some instances, each designer user profile also stores a rating and/or reviews associated with the designer.

The design data module 1032 may also be configured to store quality control data relating to expected quality of manufactured jewelry products. In some instances, the design data module 1032 stores manufacturing profile data associated with each manufacturing device 1016.

The manufacturing data module 1036 may be configured to store manufacturing data from the plurality of manufacturing electronic devices 1016. The manufacturing profile data may include, for each manufacturer associated with a manufacturing electronic device 1016, pricing information (e.g., labor costs associated with the manufacturer), manufacturing operations (e.g., one or more operations associated with jewelry manufacturing, furniture manufacturing, clothing manufacturing, or the like), and/or raw material information (e.g., raw materials to which the manufacturer has access and can use). Using the manufacturing profile data, electronic processor 1024 may provide a manufacturing portal to each of the manufacturing electronic devices 1016.

The payment module 1042 may store financial information related to jewelry orders. For example, the payment module 1042 may enable the server 1012 to act as an escrow service for holding payments during the jewelry manufacturing process and releasing the payments to the manufacturers when manufacturing is complete and certain quality control measures have been met. In this manner, the financial interests of both customers and manufacturers are addressed.

In some instances, designers may be hesitant to share designs with manufacturers at the risk of design confidential information being released or all or portions of the designs being misappropriated. Similarly, manufacturers may desire protection against related accusations. Accordingly, the custom manufacturing system 1000 provides integrated copyright registration services for designers to protect designs being transferred though the system 1000. For example, the design data module 1032 may store copyright data associated with a user profile (e.g., each project file linked to a user profile). In some instances, the electronic processor 1024 automatically generates copyright registration paperwork for designs created by the designer using the system 1000 (for example, using user profile data associated with the designer). In some instances, the electronic processor 1024 submits the copyright registration paperwork using the network interface 1020. In yet other example, the processors 1024 may generate agreements related to confidentiality or nondisclosure for the parties involved.

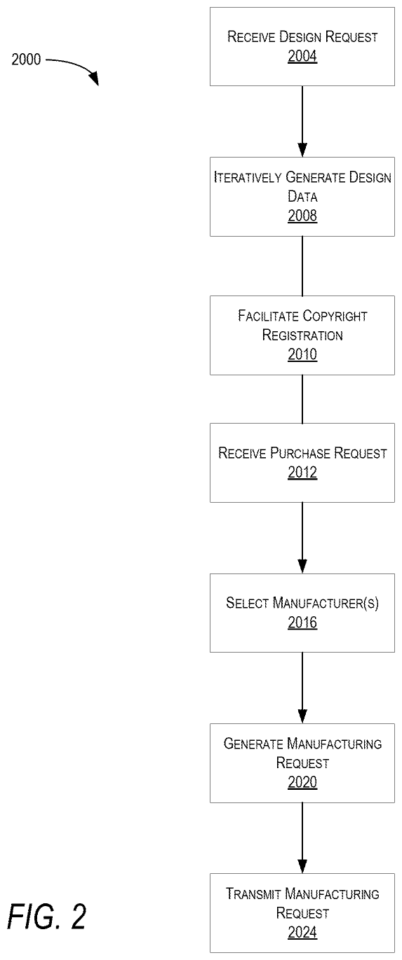

FIG. 2 is a flowchart illustrating a method 2000 performed by the electronic processor 1024 for facilitating custom manufacturing, according to some examples. The method 2000 includes receiving, from the customer electronic device 1008, a design request for a custom design (e.g., a custom jewelry design) (at block 2004). The design request may include, for example, a 2D design file (e.g., a 2D vector file, a raster file, an image, etc.), a 3D design file, and/or a text description of the design.

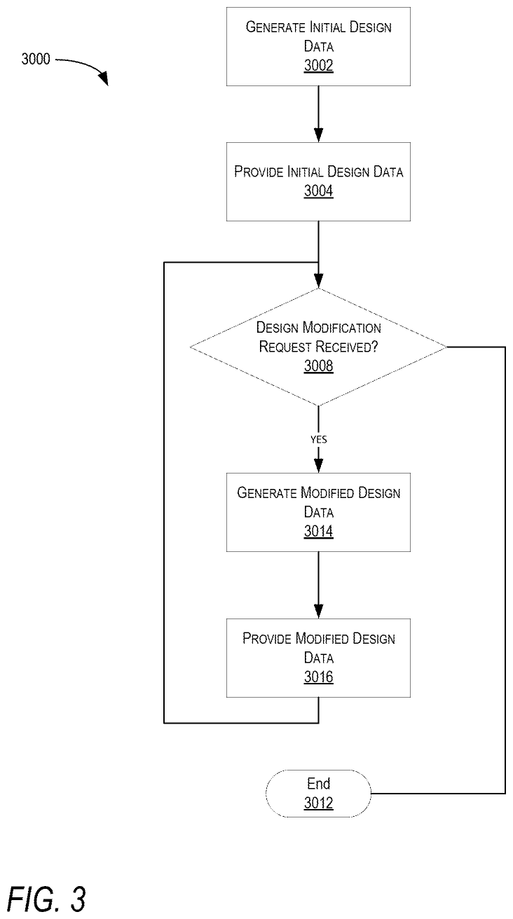

The method 2000 includes iteratively generating design data (e.g., a design data set) based on the design request and storing the design data set in the memory 1028 (e.g., in a project file associated with the design) (at block 2008). The iterative generation of the design data set will be described in greater detail herein with respect to FIG. 3. The design data set may include, for example, a 3D graphics file and specification parameters in the form of a specification sheet associated with the design. The 3D graphics file includes, for example, a CAD file, a STL file, a virtual reality file, an augmented reality file, and/or the like.

Generation of the design data may include varying amounts of collaboration with a designer electronic device 1004. In some instances, the electronic processor 1024 generates the 3D graphics file based on the design request using the machine learning module 1040. For example, the machine learning module 1040 may be operable to receive, as input, the design request, and output a visualization of the design (e.g., a 2D and/or a 3D file) based on the design request.

In some instances, the electronic processor 1024 generates the design data by providing the design request to a designer electronic device 1004, and receiving, from the designer electronic device 1008, some or all of the design data (e.g., including a 2D and/or 3D design file). For example, in some instances, the electronic processor 1024 receives a 2D design file from the designer electronic device 1004 and generates, using the machine learning module 1040, a 3D design file. In some instances, however, the electronic processor 1024 generates a 2D design file based on the design request, provides the 2D design file to the designer electronic device 1004, and receives a 3D design file from the designer electronic device 1004 based on the 2D design file.

The electronic processor 1024 may generate the specification sheet based in part on the 3D graphics file. The specification sheet details a list of raw materials, e.g., precious metals, stones, etc., required to manufacture the design. For example, the electronic processor 1024 may identify design geometries in the 3D graphics file, the geometries including volumes and surfaces for portions of the design. The identified geometries may each be associated with a type of material (e.g., gold, silver, diamond, etc.) used in manufacturing of the design. Based on volume associated with each geometry, the electronic processor 1024 may determine a material quantity for each geometry, and for the design as a whole, and generate the list of raw materials. The list of raw materials may include one or both of a quantity of raw materials included in the manufactured product and a quantity of raw materials required to manufacture the product. For example, the electronic processor 1024 may determine that a design including one ounce of gold may require 1.2 ounces of gold in order to manufacture the product to account for production inefficiencies, as some material is lost during the manufacturing process.

The specification sheet may also include a price associated with the design and/or with each material required to manufacture the design. The electronic processor 1024 may determine a price for each material using, for example, a look-up table associated with real-time market exchange values for that material. The specification sheet may also include an estimate of manufacturing costs associated with the manufacturing of the design, and/or a price markup associated with the design.

In some instances, after the design data is generated, the electronic processor 1024 facilitates a copyright registration of the design (at block 2010). For example, as described above, the electronic processor 1024 may provide the necessary forms to the designer electronic device 1004 for applying for a copyright registration of the design. In some instances, facilitating the copyright registration includes providing a redirect to, for example, a webpage associated with the copyright office of the designer's country or another selected country.

The method 2000 includes receiving, from the customer electronic device 1008, a purchase request for the design (at block 2012). As described herein, in some instances, the customer electronic device 1008 and the designer electronic device 1004 are the same device. In some instances, however, the customer electronic device 1008 and the designer electronic device 1004 are different devices. The purchase request includes, for example, a selection of the design to be manufactured and purchased, and an order quantity. The purchase request may also include customer payment information and customer shipping information.

The method 2000 includes selecting, based on the purchase request, one or more manufacturers for manufacturing the design. The one or more manufacturers may be selected based on information included in the manufacturing data module 1036 (e.g., the manufacturing profiles). In some instances, the electronic device 1024 selects the one or more manufacturers based on a quality preference. For example, the electronic processor 1024 may store historic quality control data associated with each manufacturer and select the manufacturer that historically has a relatively high or the highest quality level. In some instances, the electronic processor 1024 selects the one or more manufacturers based on manufacturing capacity. For example, when an order involves a large quantity (e.g., larger than a quantity threshold), the electronic processor 1024 may divide the order among two or more manufacturers.

For example, one manufacturer may have sufficient raw materials to fulfill the order but may not have sufficient manufacturing capacity. In another example, two or more manufacturers may have sufficient manufacturing capacity but insufficient raw materials. In another example, two or more manufacturers may have sufficient manufacturing capacity and raw materials but offer different manufacturing costs. Based on this information, the electronic processor 1024 may allocate an entire order or part of an order to a subset of the one or more manufacturers. For example, the electronic processor 1024 may allocate an entire order to one manufacturer. Alternatively, the electronic processor 1024 may allocate a first manufacturing process to a first manufacturer and allocate a second manufacturing process to a second manufacturer. In another example, the electronic processor 1024 may allocate half the order quantity to a first manufacturer and allocate the rest of the order quantity to a second manufacturer.

In some instances, the electronic processor 1024 selects the one or more manufacturers based on manufacturing operations required to manufacture the design using data stored in the manufacturing data module 1036. For example, if a jewelry design includes silver casting, the electronic processor 1024 will only select manufacturers capable of performing silver casting. In some instances, the electronic processor 1024 selects the one or more manufacturers based on the raw materials included in the design. For example, some jewelry manufacturers may not manufacture jewelry using lab-grown diamonds. Accordingly, if the specification sheet indicates that the design includes lab-grown diamonds, the electronic processor 1024 will only select manufacturers that will manufacturer products using lab-grown diamonds.

In some instances, the electronic processor 1024 selects the one or more manufacturers based on a labor and/or material cost associated with each manufacturer and a markup price associated with the design. In some instances, the electronic processor 102 provides a reverse auction portal to each of the manufacturer electronic devices 1016 (or, in some instances, to a subset of manufacturer electronic devices 1016 initially selected by the electronic processor 1024). A plurality of manufacturers is therefore able to bid on the manufacturing order, and the electronic processor 1024 may select a manufacturer based on a lowest bid price and/or a shortest estimated completion time for the order.

The method 2000 includes generating one or more manufacturing requests for the selected one or more manufacturers (e.g., based on one or more methods described above) (at block 2020). The manufacturing request may include some or all of the design data associated with the design. In some instances, the manufacturing requests also includes additional data associated with the design (e.g., additional 3D graphics files, pricing information, completion date requirements, quality control requirements, and/or the like). The method 2000 includes transmitting the one or more manufacturing requests to the one or more selected manufacturers (e.g., to the respective manufacturing electronic device 1016 associated with each selected manufacturer) (at block 2024).

FIG. 3 illustrates a method 3000 performed by the electronic processor 1024 for iteratively generating the design data set (e.g., block 2008 of FIG. 2). The method 3000 includes generating an initial design data set based on the design request (e.g., using one or more methods described above with respect to FIG. 2) (at block 3002).

The method includes transmitting the initial or intermediate design data set to the customer electronic device 1008 (at block 3004). The method includes determining whether a design modification request or a design approval from the customer electronic device 1008 with respect to the initial design data set is received (at block 3008). The design modification request includes comments or feedback from the customer based on the initial or intermediate design data. When, at block 3008, a design modification request is not received, and/or an approval is received, the iterative design data generation method 3000 is complete (at block 3012). For example, while the design data generation is described as an iterative process, in some instances, the method 3000 includes only a single iteration of generating design data and receiving approval.

When, at block 3008, a design modification request is received, the method includes generating, based on the design modification request, a modified design (at block 3014). For example, in some instances, the design modification request includes a request (e.g., a request from the customer) to modify the price of the design (e.g., to lower the price). In such instances, the electronic processor 1024 may modify the design such that the cost of the design meets a desired cost indicated in the modification request. For example, the electronic processor 1024 may modify the design data set to include fewer components (e.g., fewer diamonds in a ring), less expensive components (e.g., lab-grown diamonds as opposed to natural diamonds), components of a smaller size (e.g., a thinner ring band), and/or the like.

In some instances, the design modification request includes an addition of one or more components or materials in the design, a relocation of one or more components in the design, a resizing of one or more components of the design, a change of materials in the design, or the like. Accordingly, the electronic processor 1024 modifies the design data set, including the 3D graphics file and the specification sheet, based on the modification request. In some instances, the electronic processor 1024 provides the design modification request and/or the modified design data to the machine learning module 1040 as training data.

The method 3000 includes transmitting the modified design data set to the designer electronic device 1008 (at block 3016). The method 3000 proceeds to block 3008 and the electronic processor 1024 repeats the operations of blocks 3008 through 3016 (e.g., by generating intermediate design data) until no further design modifications are requested by the customer electronic device 1008.

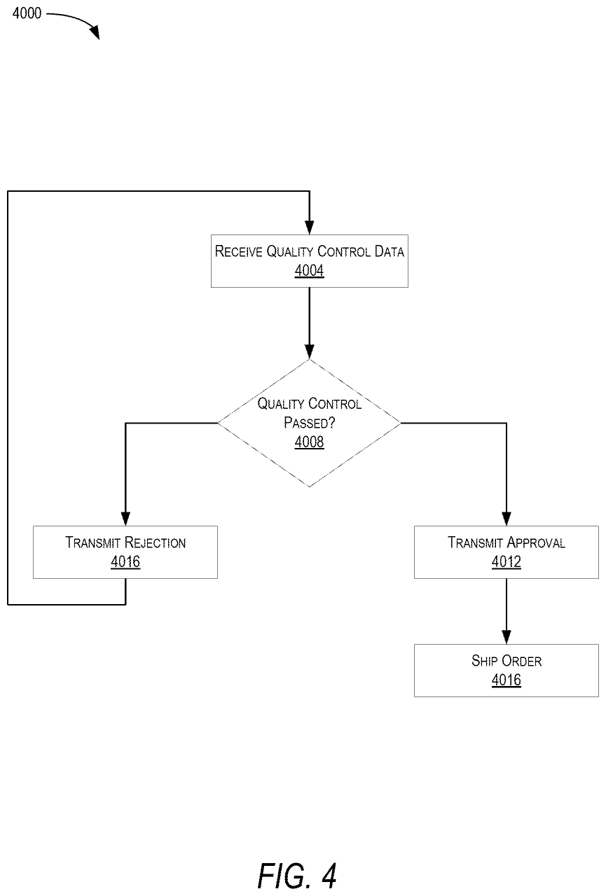

FIG. 4 illustrates a method 4000 implemented by the electronic processor 1024 in conjunction with a quality control device for performing quality control of a manufactured custom product, according to some examples. The method 4000 is performed, for example, after a manufacturer has received, processed, and manufactured a design. In some instances, the method 4000 is performed when the manufactured product is still at the manufacturing facility, and the quality control device is a manufacturing electronic device 1016. However, in some instances, the quality control device is a separate electronic device, and the server 1012 provides a quality control portal to the quality control electronic device for transmitting data to and receiving data from the quality control electronic device. In some instances, the manufactured product is shipped to a separate quality control facility or other central processing facility, and the method 4000 is performed after arrival of the manufactured product at the quality control facility or central processing facility.

The method 4000 includes receiving quality control data from a quality control electronic device (at block 4004). The quality control data includes visual or textual information associated with a manufactured product. The quality control data may include, for example, an augmented reality file, a virtual reality file, a video file, an image file, a text description of the manufactured jewelry piece, and/or the like. Quality control data may be received with respect to each manufactured product included in an order, or with respect to only a sample of manufactured products included in an order (e.g., one or more randomly selected products in the order).

The method 4000 includes determining whether the manufactured product has passed a quality control check (at block 4008). The electronic processor 1024 may analyze (e.g., using the machine learning module) the quality control data received from the quality control device in order to determine whether the quality of the product associated with the quality control data exceeds a quality control threshold. For example, the memory 1028 may store quality control software and/or metrics for guaranteeing that all finished products meet the same standards of quality. In some embodiments, the quality control software and/or metrics may be provided to the one or more manufacturing electronic devices 1016 via the network interface 1020. By providing a unified set of quality control metrics or a quality control software, the system 1000 enables different manufacturers to be held to the same quality standards prior to, or in lieu of, shipping the product to a quality control facility.

The electronic processor 1024 is configured to selectively transmit, to the quality control device and/or the manufacturing device 1016, an approval or a rejection of the quality of the manufactured product. The approval may be indicative of the manufactured product exceeding a minimum quality threshold. When the product fails to meet or exceed the quality control threshold, the rejection may be sent to the manufacturer via the communication interface 1020 (at block 4016). The rejection may include a set of quality metrics or parameters corresponding to the rejected piece of jewelry. The quality control response may include shipping the rejected piece back to the manufacturer. For example, the electronic processor 1024 may transmit a notification to a device associated with the quality control facility (e.g., the quality control device) indicating that the product should be returned to the manufacturer.

In some instances, the electronic processor 1024 provides at least one of the quality control data, the quality control metrics, the design data associated with the product, and the determination of whether the product passed quality control to the machine learning module 1040 as training data.

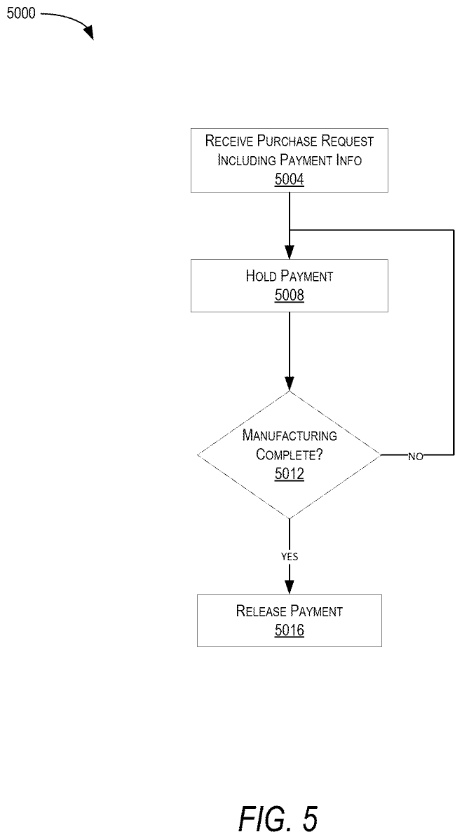

In contrast, when the manufactured product meets or exceeds the quality control threshold, the electronic processor 1024 may transmit the quality control approval response to the manufacturer (at block 4012). In some embodiments, as part of the jewelry escrow process, a quality control approval response may include a payment authorization (described in greater detail herein with respect to FIG. 5).

The method 4000 includes shipping the order to the customer (at block 4016). In some instances, the order is shipped directly from the manufacturer. However, in some instances, the order is shipped from the quality control facility or from a central processing facility.

FIG. 5 illustrates a method 5000 implemented by the electronic processor 1024 for performing an escrow process, according to some examples. The method includes receiving, from the customer electronic device 1004, a purchase request for a design (at block 5004). As described herein with respect to FIG. 2, the purchase request may include customer payment information for billing the customer for the purchase. In some instances, the purchase requests also include billing or payment authorization. In instances in which the purchase request does not include authorization for full or even partial payment of the customer order but manufacturers require some form of payment or confirmation thereof prior to actual manufacturing, a control facility acts as an intermediary between the end customer and the manufacturers such that the control facility receives payment information from the customer, the payment information obtained by the electronic processor 1024 via the customer electronic device 1008, and holds the payment during the manufacturing process (at block 5008).

The method 5000 includes determining whether the manufacturing process is complete (at block 5012). The electronic processor 1024 may determine that the manufacturing process is complete in response to determining that the manufactured product has passed quality control (e.g., using the methods described herein with respect to FIG. 4). For example, in some instances, the electronic processor 1024 receives a payment authorization from the quality control facility or other central processing facility after the quality control review of the manufactured product.

When the manufacturing process is complete, the electronic processor 1024 releases the payment or any remaining payment held with the server 1012 to the manufacturer (at block 5012). In some instances, the finished product is only shipped to the customer after payment has been released to the manufacturer.

Thus, embodiments described herein provide systems and methods for facilitating custom manufacturing. Various features and advantages of the embodiments are set forth in the following aspects:

What is claimed is:

1. An enterprise resource planning server system for facilitating manufacturing of custom jewelry, the system comprising:
at least one network communication interface configured to communicate over a network with electronic devices;
a memory storing a computer program; and
at least one server electronic processor configured by way of the computer program to:
receive a design request for a jewelry design;
generate jewelry design data based on the design request, wherein the jewelry design data includes at least a 3D graphics file and specification parameters;
provide the jewelry design data to a user;
receive feedback from the user;
modify the jewelry design data based on feedback;
receive a jewelry purchase request associated with the jewelry design;
responsive to receiving the jewelry purchase request, select a jewelry manufacturer for manufacturing the jewelry design;
generate a manufacturing request based on the jewelry purchase request; and
transmit the manufacturing request to a selected jewelry manufacturer.

2. The enterprise resource planning server system of claim 1, wherein the feedback includes a request to modify at least one selected from the group consisting of: a price associated with the design, one or more materials associated with the design, a removal of one or more components included in the design, an addition of one or more components to the design, a size of one or more components included in the design, and a location of one or more components included in the design.

3. An enterprise resource planning server system for facilitating manufacturing of custom products, the system comprising:
at least one network communication interface configured to communicate over a network with electronic devices; and
at least one server electronic processor configured to:
receive a design request for a design;
generate design data based, at least in part, on the design request, wherein the design data includes at least a graphics file and specification parameters;
receive a purchase request associated with the design;
responsive to receiving the purchase request, select at least one manufacturer for manufacturing the design;
generate a manufacturing request based on the purchase request; and
transmit the manufacturing request to a selected manufacturer.

4. The enterprise resource planning server system of claim 3, wherein the design request includes at least one selected from the group consisting of: a 2D vector file, raster file, an image, or a text description of the design.

5. The enterprise resource planning server system of claim 3, wherein the at least one server electronic processor is further configured to generate the design data iteratively by:
providing an initial design data to a user;
responsive to providing the initial design data, receiving a design modification request from the user;
generating modified design data based on the design modification request; and
providing the modified design data to the user.

6. The enterprise resource planning server system of claim 5, wherein the design modification request includes a request to modify at least one selected from the group consisting of: a price associated with the design, one or more materials associated with the design, a removal of one or more components included in the design, an addition of one or more components to the design, a size of one or more components included in the design, and a location of one or more components included the design.

7. The enterprise resource planning server system of claim 6, wherein the at least one server electronic processor is configured to generate the design data iteratively by:
using a machine learning module, generating the graphics file as a 3D graphics file based on the design request.

8. The enterprise resource planning server system of claim 7, wherein the machine learning module is configured to receive, as training data, at least one selected from the group consisting of: the design modification request and the modified design data.

9. The enterprise resource planning server system of claim 3, wherein the at least one server electronic processor generates the specification sheet based on the graphics file.

10. The enterprise resource planning server system of claim 3, wherein the design data includes a price associated with the design.

11. The enterprise resource planning server system of claim 3, wherein the purchase request is included in the design request.

12. The enterprise resource planning server system of claim 3, wherein
the purchase request includes a total order quantity for the design, and
wherein the at least one server electronic processor is configured to select the at least one manufacturer for manufacturing the design based on the total order quantity.

13. The enterprise resource planning server system of claim 12, wherein
the at least one server electronic processor is configured to select a first manufacturer and a second manufacturer,
the manufacturing request includes a first manufacturing request to be transmitted to the first manufacturer and a second selected manufacturing request to be transmitted to the second manufacturer, and
the first manufacturing request includes a first order quantity that is less than the total order quantity and the second manufacturing request includes a second order quantity that is less than the total order quantity.

14. The enterprise resource planning server system of claim 3, wherein the specification sheet includes an identification of raw materials included in the design, and the at least one server electronic processor is configured to select the at least one manufacturer for manufacturing the design based on the identification of raw materials.

15. The enterprise resource planning server system of claim 3, wherein the at least one server electronic processor is configured to select the at least one manufacturer in response to receiving a manufacturing bid from the at least one manufacturer.

16. The enterprise resource planning server system of claim 3, wherein the at least one server electronic processor is further configured to:
responsive to transmitting the manufacturing request to the selected manufacturer, receive quality control data from the selected manufacturer, wherein the quality control data includes at least one selected from the group consisting of: an augmented reality file, a virtual reality file, a video file, an image file, and a text description of a manufactured piece.

17. The enterprise resource planning server system of claim 16, wherein the at least one server electronic processor is further configured to:
responsive to receiving the quality control data, selectively transmit, to the selected manufacturer, an approval or rejection of the manufactured piece, wherein the at least one server electronic processor determines whether to transmit the approval or the rejection based on the quality control data and an output from a machine learning model.

18. The enterprise resource planning server system of claim 17, wherein
the purchase request includes payment information, and
the at least one server electronic processor is further configured to:
responsive to receiving the purchase request, store the payment information; and
responsive to transmitting an approval of the manufactured piece, release a payment to the selected manufacturer.

19. The enterprise resource planning server system of claim 16, wherein the at least one server electronic processor is further configured to:
store a project file associated with the design, wherein the project file includes at least one selected from the group consisting of: the quality control data, the design data, the design request, and the purchase request.

20. An enterprise resource planning server system, the system comprising:
at least one network communication interface configured to communicate over a network with electronic devices; and
at least one server electronic processor configured to:
receive, from a user, a purchase request to purchase a custom product, the purchase request including payment information;
store the payment information in a memory;
select at least one manufacturer for manufacturing the custom product based on at least one selected from the group consisting of: a total order quantity associated with the purchase request, raw materials included in a design of the custom product, a bid from the at least one manufacturer, a product cost, and stored quality control data associated with the at least one manufacturer,
generate a manufacturing request based on the purchase request;
transmit the manufacturing request to a selected manufacturer;
receive an indication that the at least one manufacturer completed manufacture of the custom product,
receive quality control data associated with the custom product,
determine whether the quality control data meets a set of quality control parameters,
responsive to determining that the quality control data meets a set of quality control parameters, release a payment, using the payment information, to the at least one manufacturer.
